(19) United States
(12) Patent Application Publication
(10) Pub. No.: US 2003/0120742 A1
(43) Pub. Date: Jun. 26, 2003

(54) Home network system

(76) Inventors: Yoichi Ohgami, Yamatokada-shi (JP); Kohzoh Hirata, Osaka (JP); Akira Shibata, Yamatokoriyama-shi (JP)

Correspondence Address: BIRCH STEWART KOLASCH & BIRCH, PO BOX 747, FALLS CHURCH, VA, 22040-0747, US

(21) Appl. No.: 09/983,260

(22) Filed: Oct. 23, 2001

(30) Foreign Application Priority Data
Oct. 23, 2000 (JP) 2000-322384

(51) Int. Cl. G06F 15/16

(52) U.S. Cl. 709/217

(57) ABSTRACT

In the system, a home server collectively receives and demodulates signals of satellite broadcasts, TV broadcasts, CATV broadcasts and telecommunication data by its receiving and demodulating portion, and, upon receipt of a request from a user display device, selects a broadcasting channel and converts the channel signal into a common data signal by its digital signal processing portion. The home server decides an address of the display device and a transmission means, modulates the common data signal by its radio control portion and, then, transmits the signal through an aerial portion thereof to the display device. The video signal from the home server is received by the display device through its antenna, wherein the signal is demodulated by a radio control portion and transferred to a recognition portion for recognizing the address of the display device or signal conversion device for displaying the video signal.

### BACKGROUND OF THE INVENTION

The present invention relates to a home network system in which a home server can collectively receive broadcasts and data communication services and selectively distribute received contents to a plurality of home display units for displaying the received contents and a variety of home electronic devices located at various places in a house by means of radio or indoor wirings.

Recently, there has been available avariety of broadcasting services which are analog terrestrial broadcasts, analog satellite broadcasts, digital satellite broadcasts, CATV and so on. Generally, subscribers-viewers selectively receive broadcasts at own home terminals according to own preferences, local conditions and service contents.

In addition, the development of the digital technology accelerates the digitalization of the broadcasting services including digital satellite broadcast and digital terrestrial broadcasting services, all of which are now starting proving digital broadcasting services to users.

FIG. 1 is a block diagram of a conventional indoor connection system for receiving broadcasting services. Referring to FIG. 1, the indoor connection system for receiving the above-mentioned available broadcasting services by a home terminal or terminals is described below.

In FIG. 1, there is shown a service provider 101 for providing information, a terrestrial broadcasting company 111 for providing broadcasting programs over terrestrial waves, a satellite broadcasting company (analog broadcasting company) 112 for providing broadcasting programs to subscribers using a broadcasting satellite, a satellite broadcasting company (digital broadcasting company) 113 for providing broadcasting programs to subscribers using a communication satellite a CATV broadcasting company 114 for providing AV programs to subscribers through a cable network and a telecommunication company 115 for providing communication services to subscribers over a telecommunications network. There is also shown an antenna 111a for receiving terrestrial broadcast signals, an antenna 112a for receiving analog satellite broadcasts, an antenna 113a for receiving digital satellite broadcasts, a mixer 150 for mixing broadcast signals received through the antennas 111a and 112a, a distributor 152 for receiving signals via a coaxial cable 130 and distributing them via coaxial cables 131-133 to terminals in separate rooms a-c, a distributor 153 for distributing signals received via the digital satellite broadcast receiving antenna 113a to terminals in separate rooms a and b by means of coaxial cobles 134 and 135, and a distributor 154 for receiving signals via an outdoor cable 114a from the CATV network and distributing them via coaxial cables 136 and 137 to terminals in separate rooms a and b. Analog satellite broadcast receivers (set top boxes (STB) for analog satellite broadcasts) 162a and 162b unscramble an analog satellite broadcast received through the analog satellite receiving antenna 111a and control the selection of analog satellite broadcasting channels, a digital satellite broadcast receiver (STB) 163 unscrambles a digital satellite broadcast received through the digital satellite receiving antenna 112a and controls selection of digital satellite broadcasting channels, and CATV receivers (STB) 164a and 164b unscramble a CATV broadcast received through the outdoor cable 114a and control selection of CATV channels. AV selecting means 121a, 121b and 121c are used for switching corresponding displays to video inputs selected from plural external video inputs respectively, a connection cable 140 is used for transferring unscrambled video output signals from the STB (for digital satellite broadcasting) 163 to AV selecting means 121a, a connection cable 141 is used for transferring unscrambled video output signals from the STB (for CATV) 164a to AV selecting means 121a, a connection cable 142 is used for transferring unscrambled video output signals from the STB (for analog satellite broadcasting) 162a to AV selecting means 121a, a connection cable 143 is used for transferring unscrambled video output signals from the STB (for CATV) 164b to AV selecting means 121c, and a connection cable 144 is used for transferring unscrambled video output signals from the STB (for analog satellite broadcasting) 162b to AV selecting means 121b. Television terminals 120a, 120b and 120c are provided with the AV selecting means 121a, 121b and 121c respectively. Numeral 100 designates an indoor connection system.

The indoor connection system 100 allows a user to observe TV programs on the television terminals located in separate rooms “a”, “b”, “c” and “d” as follows:

In room “a”, the user can enjoy any of four kinds of broadcasting services: terrestrial broadcast, analog satellite broadcast, digital satellite broadcast and CATV broadcast.

In room “b”, the user can enjoy any of three kinds of broadcasting services: terrestrial broadcast, analog satellite broadcast and CATV broadcast.

In room “c”, the user can enjoy any of two kinds of broadcasting services: terrestrial broadcast and analog satellite broadcast.

In room “d”, no broadcast service is enjoyed.

The above-described system may subject the user to the following inconveniences:

(1) To enjoy various broadcasting services, the user selects in advance a place (room) for watching the broadcasting services, extends thereto respective coaxial cables from respective antenna receivers coupled to respective antennas, connects the cables to respective specific receivers and finally connects the respective specific receivers to a television receiver(s) by cables.

(2) In order to enjoy the various kinds of broadcasts in another place (a room other than the selected place (room)), the user must extend thereto a coaxial cable from a distributor connected to respective aerial portions.

(3) To change the receiving place (room) for a particular broadcast service to another place (room), the user must extend thereto a coaxial cable from a distributor connected to a corresponding aerial portion, disconnect the corresponding receiver, replace it to the new place and then reconnect the receiver to the display unit at the new place.

(4) The user cannot receive all kinds of broadcasts on a single television receiver and can enjoy only a limited number of the broadcasting services, each of which is received by a specific receiving means connected to a corresponding AV selecting means of the television receiver.

### SUMMARY OF THE INVENTION

A primary object of the present invention is to provide a home network system capable of allowing a user to enjoy a variety of broadcasts, communication data and stored video programs at any desired indoor place (room) with no special wiring works.

Another object of the present invention is to provide a home network system capable of collectively receiving signals from various broadcasting and communication enterprises by a single home server via cables and selectively transmitting received signals to any TV terminal located in a desired place (room) by means of radio transmission.

Another object of the present invention is to provide a home network system capable of allowing the user to enjoy any desired video program on any display device in any room via radio transmission from a single home server, eliminating the need for connection with aerial portions, display and a separate device corresponding in function to the home server.

Another object of the present invention is to provide a home network system capable of allowing the user to enjoy the same contents on every display device since all functions of a home server can be commonly used by all display devices in the home network.

Another object of the present invention is to provide a home network system in which a home server collectively receives all kinds of signals from external broadcasting and communication services via a coaxial cable and a signal conversion device is used for receiving a desired broadcast signal from the home server and converting the signal into a television signal to be displayed on an existing television receiver lacking a function for receiving signals from the home server.

Another object of the present invention is to provide a home network system in which a signal conversion device can receive/transmit signals from/to a home server by means of radio transmission or cable transmission with no need for connection with aerials, television receiver and a separate device equivalent to the server. This enables one to watch signals from the server on a television receiver at a desired place (room), which receiver cannot receive any signal directly from the home server.

Another object of the present invention is to provide a home network system in which a signal conversion device enables a television receiver to receive all contents-functions of a home server.

Another object of the present invention is to provide a home network system in which a home server capable of collectively receiving and storing externally inputted broadcast signals, packed audiovisual media and audiovisual information can transmit and receive audiovisual data to/from each of stationary/portable display devices (e.g., a LCD monitor) by means of radio transmission, and can be operable at a distance from each display device by using a remote control and a keyboard/mouse as an interface between them.

Another object of the present invention is to provide a home network system in which audio and video signals from a home server can be received by each display device that incorporates terminals for receiving a light or radio transmission signal from a control device such as a remote control, keyboard/mouse and can receive a request signal from the control device and transmit the received request signal to the home server that in turn operates by the request signal.

Another object of the present invention is to provide a home network system in which a home server can serve N display devices and mutually recognize each of the display devices in such a manner that the server sends a recognition signal to a display device that in turn recognizes the received signal and returns a response signal to the server.

Another object of the present invention is to provide a home network system in which a home server is capable of transmitting a recognition signal to each of display devices and adding an address to each display device after receiving a response signal therefrom, and each display device is capable of receiving a signal from the home server, recognizing the received signal and returning the recognized signal to the server, wherein the display device is provided with means for receiving signals from the home server and means for transmitting a request signal to the server, wherein the home server and each display device can always communicates each other just after the latter is switched on and the home server can always recognize a plurality of display devices.

Another object of the present invention is to provide a home network system in which a home server can converts all received signals from the different external stations into data signals common in the home network system and transmit them to each of display devices by a radio transmission method SS or OFDM.

Another object of the present invention is to provide a home network system wherein a home server transmits signals each with address information for respective designations-display devices not to cause interference between signals of the same radio frequency.

Another object of the present invention is to provide a home network system wherein a home server can be controlled in its output power in accord with absorption and insulation of radio waves by the structure (e.g., wooden, reinforced concrete structure) of a house and a transmission distance from the object.

Another object of the present invention is to provide a home network system wherein a home server can transmit signals to a plurality of display devices by using plural channels within the same frequency band, selecting an optimal band for each circumstance.

Another object of the present invention is to provide a home network system wherein a home server can select one of radio frequency bands for different transmission rates in accord with the type of data to be transmitted.

Another object of the present invention is to provide a home network system wherein each display device can be provided with inputting means such as a keyboard/mouse when the display device is used as a personal computer.

Another object of the present invention is to provide a home network system wherein each display device incorporates terminals of a light transmission element and a radio transmission element necessary for remotely driving and controlling a home server when watching broadcast/communications on the display device.

Another object of the present invention is to provide a home network system wherein a home server collectively receives and stores externally inputted broadcast signals, audiovisual signals (package media) and audiovisual information, a signal conversion device converts audiovisual data from the home server into a common audiovisual data and plural existing stationary and/or portable display devices can receive the converted data and transmit the data by radio, and the home server can be operable at a distance from each display device by using a remote control and a keyboard/mouse, which are an interface of the display device.

Another object of the present invention is to provide a home network system wherein a signal conversion device capable of receiving audio and video signals from a home server, converting the received signals into television signals and outputting the converted signals to a television receiver that can not directly receive and decode signals from the server but can receive and display the converted signal from the signal conversion device through its input terminal connected thereto.

Another object of the present invention is to provide a home network system wherein a home server can serve N sets of signal conversion devices and mutually recognize each of the converting devices in such a manner that the home server sends a signal for recognizing a display device to the signal conversion device serving the recognized display device and the signal conversion device then returns the recognized signal to the home server that in turn gives an address to the converting device.

Another object of the present invention is to provide a home network system wherein a home server has a function for transmitting a display device recognition signal to every signal conversion device that has functions for receiving the signal from the home sever, recognizing the received signal and returning the recognized signal to the home server. The signal conversion device is provided with means for receiving a signal from the home server and means for sending a request signal to the home server.

Another object of the present invention is to provide a home network system wherein, in the case of adding (using) a new signal conversion device, a home server and the new signal conversion device recognizes each other and the signal conversion device can always communicate with the home server immediately after it is switched on. The home server is capable of recognizing a plurality of the signal conversion devices.

Another object of the present invention is to provide a home network system wherein, in the case of adding (using) a new signal conversion device, a home server and the new signal conversion device mutually recognize each other and the home server produces a new address and gives it to the newly added signal conversion device. The address of the signal conversion device is effective while the home server operates. The signal conversion device is given an address just after re-starting the home server.

### BRIEF DESCRIPTION OF THE DRAWINGS

FIG. 1 is a block diagram showing a conventional indoor connection system.

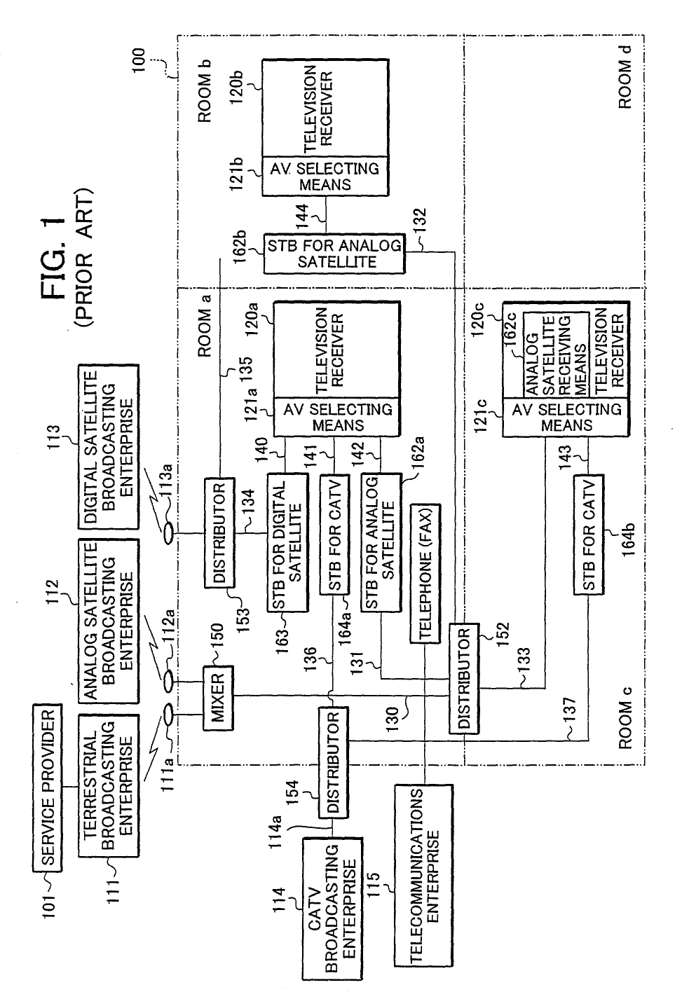

FIG. 2 is a schematic construction block diagram of a home network system according to the present invention.

FIG. 3 is a block diagram depicting mutual recognizing means between a home server and a display device or a signal conversion device composing the home network system shown in FIG. 2.

FIG. 4 is a flowchart depicting a procedure for mutual recognition between a home server and a display device or a signal conversion device composing the home network system shown in FIG. 2.

FIG. 5 is a block diagram depicting a construction of a home server comprising a home network according to the present invention.

FIG. 6 is a block diagram depicting an internal construction of a radio control portion in a home server according to the present invention.

FIG. 7 is a flowchart depicting a procedure for transmission power/direction control for a home server according to the present invention.

FIG. 8 is a view for explaining how to determine the working condition category (one of sections A, B, C, D, E, F, G and H in the matrix) based on the data “house structure” and “house area” and input parameters of FIG. 7.

FIG. 9 is a flowchart depicting an operation procedure of an automatic frequency switching means provided in a home server for transmitting signals to a display device (signal conversion device).

FIG. 10 depicts a criterion for operating an automatic frequency switching means provided in a home server for transmitting signals to a display device (signal conversion device).

FIG. 11 is a block diagram depicting a construction of a display device composing a home network system according to the present invention.

FIG. 12 shows an external appearance of a signal conversion device composing a home network system according to the present invention.

FIG. 13 is a block diagram depicting a construction of a signal conversion device composing a home network system according to the present invention.

### PREFERRED EMBODIMENT OF THE INVENTION

The present invention is directed to a home network system for collectively accumulating and distributing information, which comprises a home server having distributing means for effectively providing any of public broadcasts/media and local video information from the outside to all indoor places, a large capacity storage means for accumulating received media and a personal computer facility for information retrieval and management control, a display device having a means for receiving a signal from the home server having means for adding an input function necessary for transmitting a request signal to the home server and/or a signal conversion device having a means for receiving a signal from the home server and serving a display device lacking means for adding an input function necessary for transmitting a request signal to the home server.

The home server has functions for receiving all public/commercial broadcasts, connecting to a communication line (e.g., telephone line), reproducing package media, recording a large amount of received data, performing personal computer operations, transmitting received broadcast signals to display devices by radio or cables and operating with a remote control.

The display device has functions for receiving signals from the home server, transmitting a request signal to the home server, inputting a request signal, reproducing a semiconductor memory card and connecting digital AVC devices thereto. Namely, the display device not only serves as a terminal of the network but also serves as a station for expanding the system.

The request signal inputting function of the display device may be realized by connecting thereto a remote control, a keyboard and a mouse. The device also has an output means for outputting data to a printer and the like.

The signal conversion device has functions for receiving a signal from the home server, transmitting a received audiovisual signal to a television receiver unable of directly receiving a video signal from the home server, sending a request signal to the home server and inputting a request signal.

A home network system according to a preferred embodiment of the present invention will be described below with reference to the accompanying drawings.

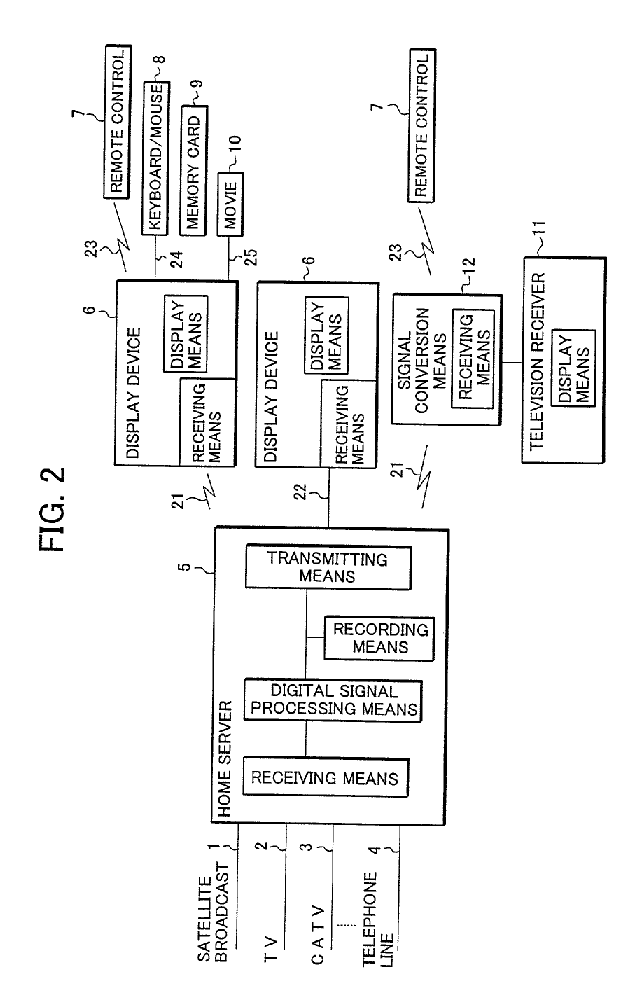

FIG. 2 is a schematic general construction view of a home network system according to the present invention.

In FIG. 2, numerals 1, 2, 3 and 4 designate a satellite broadcasting signal, a TV broadcasting signal, a CATV broadcasting signal and a communication data signal respectively.

Numeral 5 denotes a home server having a receiving means (first receiving means) for receiving a plurality of transmission signals, a data signal processing means, a recording means and a transmitting means.

Numeral 6 denotes a display device having a receiving means (second receiving means) for receiving a signal from the home server 5, a display means, and a remote control 7 by infrared transmission 23 as an interface, and a keyboard/mouse 8 connected thereto by a cable 24.

The display device 6 may connect thereto an external input means such as a memory card 9 and a movie 10 with a cable 25.

Numeral 12 denotes a signal conversion device that may serve as a receiving means connectable to a television receiver 11 that has not a function for receiving a signal from the home sever 5.

The home server 5, display device and a signal conversion device 12 are connected to one another by radio transmission 21 and cable transmission 22.

The home network system composed of the above components and its operation will be described as a preferred embodiment of the present invention.

Referring to FIG. 2, the operation of the display device 6 and the signal conversion device 12 is described first as follows:

Using a remote control 7, a user turns on the display device 6, selects a desirable one of subscribed satellite broadcasting signal 1, TV broadcasting signal 2, CATV broadcasting signal 3 and communication data 4 to be supplied by communication providers and transmits the operation/control signal 23 to the display device 6 that in turn transmits a request signal to the home server 5 by radio 21.

Upon receipt of the request signal from the display device 6, the home server 5 receives a requested video signal through the receiving means and transmits it through the digital signal transmitting means to the display device 6.

Using a remote control 7, the user turns on the signal conversion device 12, selects a desired one of subscribed broadcasting signals 1 to 3 and communication data 4 to be supplied by communication service providers and transmits the operation/control signal 23 to the signal conversion device 12 that in turn transmits a request signal to the home server 5 by radio 21 or cable 22.

Upon receipt of the request signal from the signal conversion device 12, the home server 5 receives a requested video signal through its receiving means and transmits the video signal through its digital signal transmitting means to the signal conversion device 12.

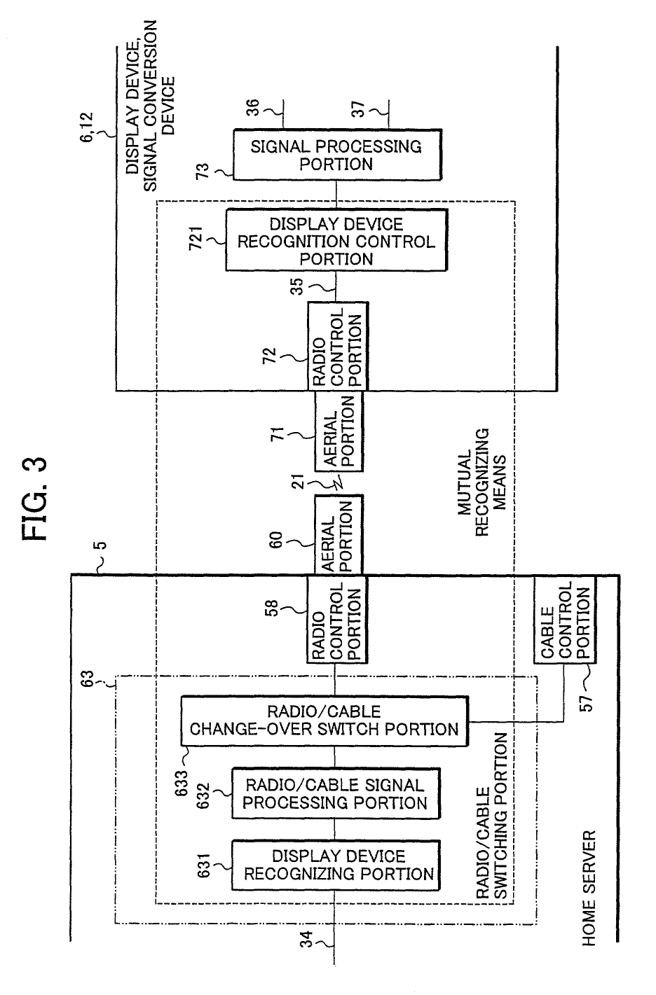

FIG. 3 is a block diagram of mutual recognition system used by the home server and the display device or the signal conversion device, which composes the home network system shown in FIG. 2. A display device (signal conversion device) recognizing means is composed of a display device (signal conversion device) recognizing portion 631 and a radio/cable transmission signal processing portion 632.

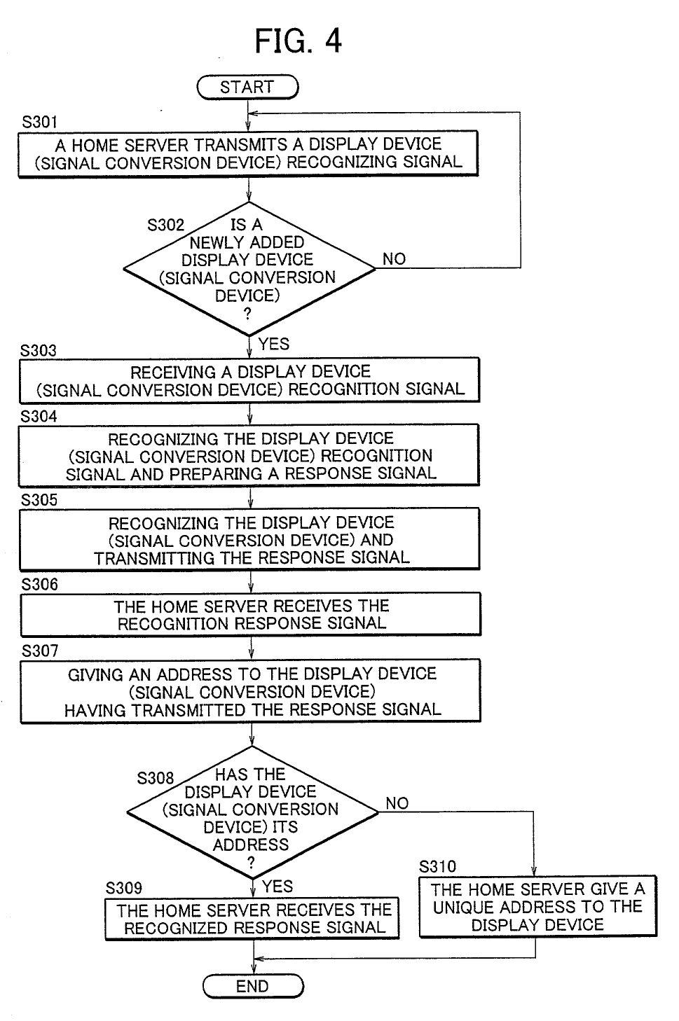

FIG. 4 is a flowchart depicting a procedure for mutual recognition by the home server and the display device or the signal conversion device, which composes the home network system shown in FIG. 2.

Referring to FIGS. 3 and 4, the operation of the mutual recognition system between the home server and the display device or the signal conversion device is described as follows:

The mutual recognition system is used for mutual recognition between the home server 5 and the display device 6 or the signal conversion device 12. Namely, the mutual recognition is conducted between a display device (signal conversion device) recognizing portion 631 in a radio/cable switching portion 63 of the home server 5 and a display device recognition control portion 721 of the display device 6 (signal conversion device 12).

The mutual recognition is conducted between the display device (signal conversion device) recognizing portion 632 of the home server 5 and the display device recognition control portion 721 of the display device 6 (signal conversion device 12) via a radio/cable signal processing portion 631, a radio/cable change-over switch portion 633, a radio control portion 58, an aerial portion 60 (a cable control portion 57 for cable transmission) provided in the home server 5 and an aerial portion 71 and radio control portion 72 provided in the display device 6 (signal conversion device 12). Transmission between the aerial portions 60 and 71 is conducted by radio 21.

Referring to FIGS. 3 and 4, the procedure for recognizing by the home server 5 each of the display devices 6 (signal conversion devices 12) in a house is described as follows:

A display device recognizing signal is periodically transmitted from the display device (signal conversion device) recognizing portion 631 of the home server (Step S301).

The signal from the recognizing portion 631 is transferred to the radio/cable signal processing portion 632 that in turn transfers the signal to both the radio control portion 58 and the cable control portion 57, which in turn transmit a recognition signal by radio and a cable respectively. In this case, the radio control portion 58 modulates the recognition signal for transmission by radio and transmits it through the aerial portion 60.

When a new display device 6 (signal conversion device 12) entered into the home network (Step S302) and received the recognition signal through its aerial portion 71 (Step S303), the device demodulates the received signal by its radio control portion 72 and transfers the demodulated signal to its display device (signal conversion device) recognition control portion 721.

In the device recognition control portion 721, the recognition signal is recognized and a response signal is prepared (Step S304).

The response signal prepared by the device recognition control portion 721 is transferred to the radio control portion 72 whereby it is modulated and then transmitted through the aerial portion 71 to the home server 5 (Step S305).

The home server 5 receives the response signal from the display device 6 (signal conversion device 12) through the aerial portion 60 and transfers it through the radio control portion 518 and radio/cable signal processing portion 632 to the device recognizing portion 631 for recognition of the response signal (Step S306).

The device recognizing portion 631 recognizes the received response signal and attaches address information to the display device 6 (signal conversion device 12) (Step S307).

At this time, the portion examines whether the display device has been given a specified address (Step S308).

If the display device has an address, the device recognizing portion 631 of the home server 5 uses the same address for identifying the same display device (Step S309).

If no address information is found for the display device 6 (signal conversion device 12), the device recognizing portion 631 of the home server 5 attaches a unique address to the display device 6 (Step S310).

Then, transmits the address information to the display device 6 (signal conversion device 12).

The display device 6 (signal conversion device 12) receives the address information and stores in a memory of the device recognition control portion 721.

This address information is necessarily attached to every request signal to be transmitted from the display device 6 or the signal conversion device 12 to the home server 5.

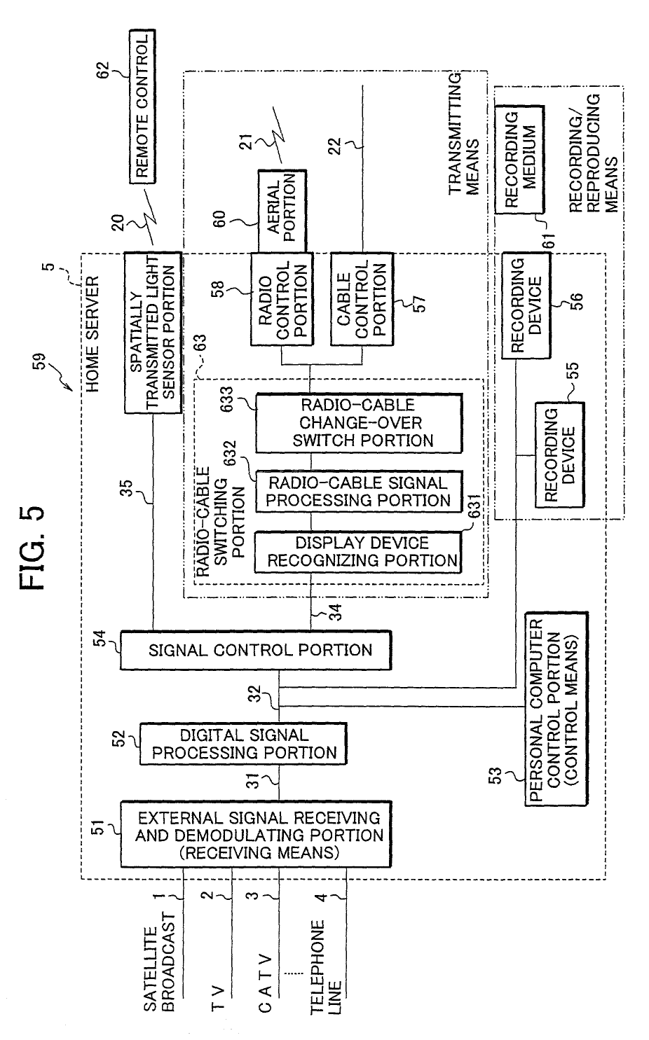

FIG. 5 is a construction block diagram of a home server composing the home network system according to the present invention.

The home server 5 can collectively receive all incoming signals of satellite broadcast 1, television broadcast 2, CATV broadcast 3 and communication line 4.

The home server 5 is composed of an external signal receiving/demodulating portion 51, a digital signal processing portion 52, a personal computer control portion 53, signal control portion 54, a recording/reproducing means including an internal recording device 55, a portable recording device 56 and recording media 61, and a transmission means including a radio/cable switching portion 63, radio control portion 58, aerial portion 60 and light transmitting element 59.

The home server 5 may be controlled by infrared transmission 20 from a remote control 62.

Signals from the home server 5 may be transmitted to the display device by radio 21 and a cable 22.

The operation of the home server 5 is as follows:

As sown in FIG. 5, signals of different type broadcasts 1 (satellite), 2 (TV), 3 (CATV) and 4 (telephone line) from the outside are received and demodulated by the external signal receiving/demodulating portion 51 of the home server 5.

The portion 51 selects a broadcast channel according to a request signal received from the user and transfers it to the digital signal processing portion 52 provided for converting the signals into common data signals, which operation is necessary for building the home network system.

Namely, the digital signal processing portion 52 has a function for converting signals of plural different broadcasts into common data signals that can be treated with no additional conversion further in the home server 5 and transmitted to the display device 6 or signal conversion device 12. This makes the home server be simple in construction and enables the display devices 6 and the signal conversion devices 12 to be commonly used.

The home server 5 according to the present invention is provided with recording/reproducing means.

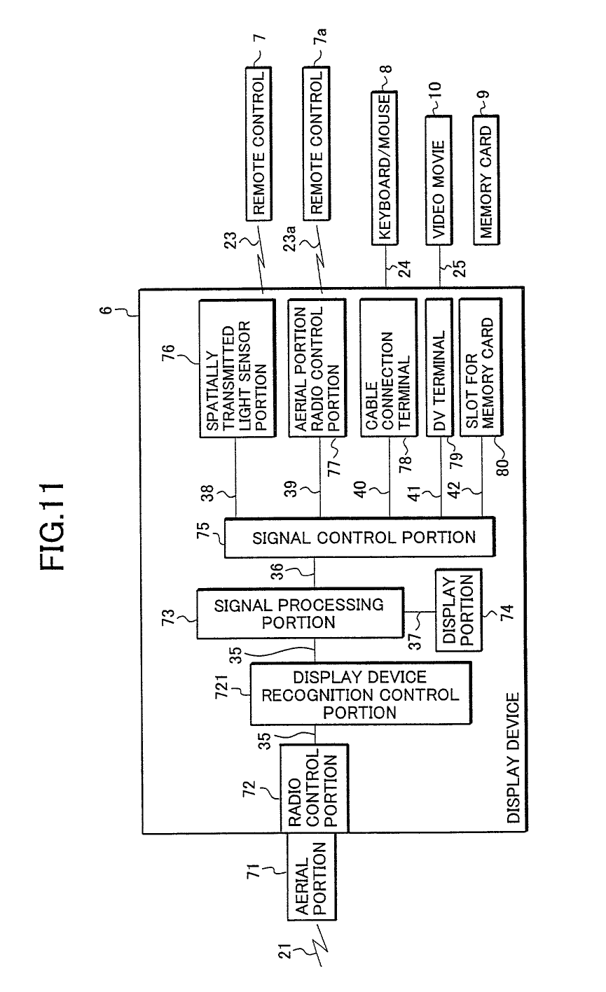

The recording means comprises an internal recording device 55, portable recording device (package media) 56 and recording medium 61. Broadcast signals can be recorded on the internal recording device 55 and the portable recording device 56 by a user's request signal transmitted from the display device 6 (signal conversion device 12). The request signal can be prepared by the user by operating the display device 6 (signal conversion device 12) by using a remote control 7 (with an infrared transmitter 23) or a remote control 7a (with a radio transmitter 23a in FIG. 11).

The user's request signal for recording a specified broadcast is transmitted from the remote control 7 and the remote control 7a through the display device 6 (signal conversion device 12) to the home server 5 in which the external signal receiving/demodulating portion 51 selects the required channel according to the received user's request signal, the digital signal processing portion 52 converts the channel signals into common signals and the internal recording device 55 records the signals on its storage. The recording method of the recording device 55 may be any one or a combination of magnetic, photo-magnetic, phase-change, and pigment recording methods.

The portable recording device (package media) 56 can record signals on recording medium 61. The recording method of this recording device 56 may be any one or a combination of magnetic, photo-magnetic, phase-change and pigment types.

The internal recording device 55 and the portable recording device (package media) 56 can reproduce recorded information.

The reproducing procedure is as follows: The user prepares and transmits a reproduction request signal from the remote control 7 or the remote control 7a through the display device 6 or the signal conversion device 12 to the home server that in turn cause the internal recording device 55 to reproduce a recorded video from its storage by the user's request. The home server transmits the reproduced video signal from the signal control portion 54 to the display device 6 (signal conversion device 12).

The procedure for reproducing the data recorded on the recording medium 61 is as follows:

The recording medium 61 with data recorded thereon is inserted into the portable recording device 56. The user's request is transmitted from the remote control 7 or the remote control 7a through the display device 6 to the home server 5 that in turn causes the portable recording device 56 to reproduce the data from the recording medium 61 and transmit to the display device 6.

The home network system according to the present invention enables the user to directly operate the home server 5 by using a remote control 62 (for the home server) in the case of coexisting the user's display device 6 and the home server in the same room.

In this situation, for example, are production request signal from an infrared transmitter 20 of the remote control 62 is directly transmitted to the home sever 5, wherein it is received by a light transmitting element 35 and transferred therefrom to the signal control portion 54. The request signal causes the signal control portion 54 to reproduce data from the recording medium 61 and transmit the reproduced data through the signal control portion 54, device recognizing portion 631, radio/cable signal processing portion 632, radio control portion 58 and aerial portion 60 to the display device (signal conversion device 12).

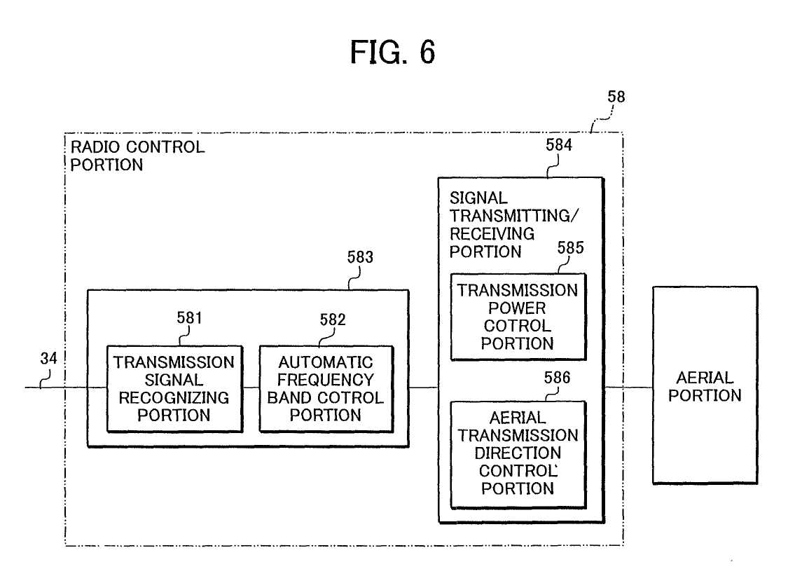

FIG. 6 is a block diagram showing an internal construction of a radio control portion of a home server according to the present invention.

The radio control portion 58 comprises a automatic frequency control processing portion 583 including a transmit-signal recognizing portion 581 and an automatic frequency control portion 582, and a signal transmitting/receiving portion 584 including a transmission power control portion 585 and an aerial transmission direction control portion 586.

The home network system according to the present invention is capable of transmitting signals by radio having a power and a direction suitable to a distance from the target and a direction thereto.

The signal transmitting/receiving portion 584 of the radio control portion 58 within the home server 5 is provided with the transmission power control portion 583 for controlling the radio transmission distance and a aerial transmission direction control portion 586 for controlling the radio transmission direction.

Data signals are transmitted by a radio suitably controlled by the transmission power control portion 585 and the aerial transmission direction control portion 586.

The transmission power control portion 585 has preliminarily inputted information on the house structure, indoor area and transmission distance.

The information is input into the home server 5 by selecting “reinforced-concrete” or “wooden frame” structure and inputting an area or a transmission distance by using a remote control 62.

Directional aerial data and desired directions are selected or input for the aerial transmission direction control portion 586.

The transmission power/direction control can be performed by software in addition to a physical control method.

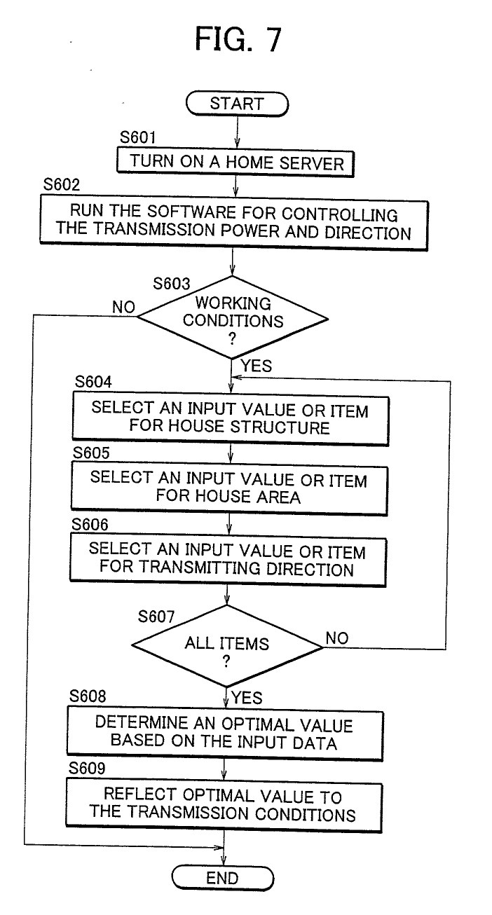

FIG. 7 is flowchart depicting a procedure for controlling a transmission power and a transmission direction by the home server according to the present invention.

The transmission power/direction control is conducted by using software for monitoring signal transmission conditions of the home server. For this purpose, the necessary data regarding the house construction and the working area of the home network system is input in advance into the home sever in the interactive mode.

First, the home server 5 is driven (Step S601) from the display device 6 (signal conversion device 12) and the software is then driven (Step S602).

The working conditions are recognized by the software (Step S603). Settings of the transmission power/direction control are done by selecting or inputting either of “reinforced concrete structure” or “wooden structure” in response to the first enquiry for the house structure” from the software (Step S604) and then by selecting one of the house area classes or an actual area value in response to the second enquiry for the house area (Step S605). In response to the next enquiry for the transmission direction, the required direction toward the display device is input or selected from the shown directions (Step S606).

The software judges whether all enquiries were input (Step S607). When the all necessary data were input, the software calculates optimal control values from the input data (Step S608), which control values shall be reflected to the transmission of signals from the home server to the display device (Step S609).

Furthermore, the transmission direction from the home server to the display device can be controlled based on the construction and directivity of the radio antenna of the home server. The directional aerial portion of the home server is set to cover all radio-transmission directions and a specified direction toward a particular display device is selected by selecting a corresponding antenna or a combination of antennas thereof. The aerial portion may be provided with a rotation mechanism for changing its direction. A plurality of antennas may be used.

Since all the above control items can be achieved by the home server and the software, the home server can be easily adapted to any modified working situation, for example, of a renewed structure of the house.

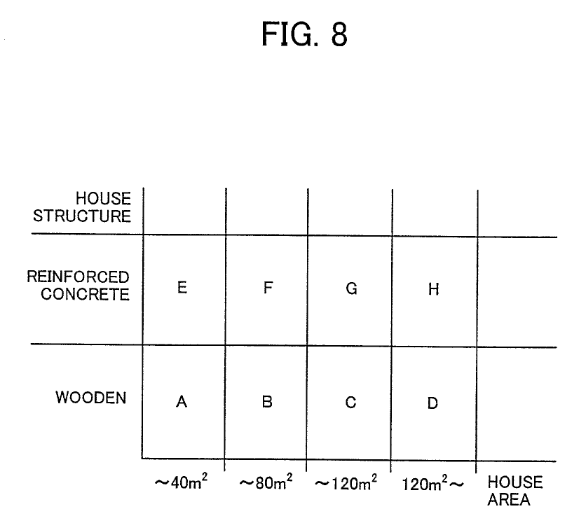

FIG. 8 is a view for explaining how to determine the working condition category (one of sections A, B, C, D, E, F, G, H in the matrix) based on the data “house structure” and “house area” inputted as described with reference to FIG. 7.

The categories requires a larger output power in the order of H>D>G>C>F>B>E>A.

While the optimal values of the input data, which have been calculated according to the flowchart of FIG. 7, are applied as the reference data for the output power, the reference category (A, B, C, D, E, F, G, H) for the output power is now determined from FIG. 8. The house structure and area (maximum transmission distance) are not limited to the shown parameters and may be separately set by the user.

The aerial portion 60 may be composed of a directional antenna provided with a rotation mechanism enabling the antenna to change its direction or a plurality of different directional antennas to be selected to meet the required transmission direction. The radio control portion 58 can regulate output power of each of the directional antennas to meet the transmission distance requirements to cover all the indoor places of the house.

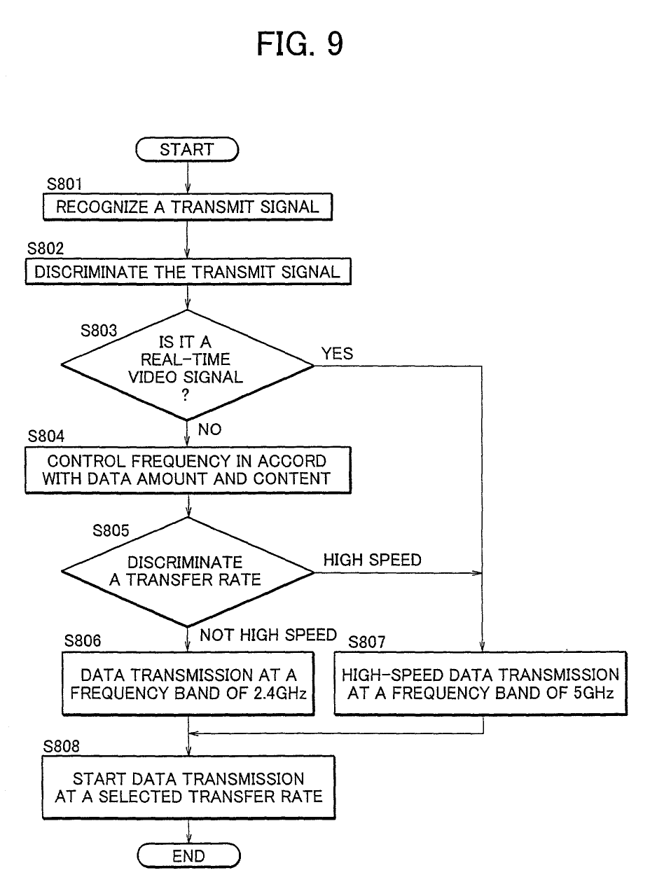

FIG. 9 is a flowchart depicting a procedure for selecting a frequency band by an automatic frequency selecting means of a transmitting means in a home server according to the present invention when transmitting a signal to a display device.

In the case of transmitting a broadcast program or video containing a large amount of data, the home server can decide the use of a frequency band for a larger transfer rate.

When transmitting external video signals (TV, CATV and satellite broadcast) and DVD video signals, the automatic frequency band control means automatically switches the transfer frequency to 5 GHz (transferrate). Namely, with a user's request signal regarding the external video signals (TV, CATV and satellite broadcasts) and DVD video signals, the frequency band of 5 GHz capable of transferring video signals can be automatically selected.

When transmitting data signals by radio from the home server to the display device 6 recognized by the display device recognizing portion 631 (signal conversion device 12), the transmission signal recognizing portion 581 recognizes signals required to be transmitted (Step S801), the automatic frequency-band control portion 582 identifies the required transmittable signals (Step S802) and decides whether the transmittable signals are of real-time video (Step S803).

If not, the transfer frequency band is determined based on the amount and content of the transmittable data (Step S804) and the suitable frequency band (transfer rate) is selected (Step S805).

For data requiring transmission at a high transfer rate, the frequency band of 5 GHz for high-speed data transmission is selected (Step S807). If not, the frequency band of 2.4 GHz is selected (Step S806). The data is transmitted at the selected frequency band (transfer rate) (Step S808).

For the real time video data, the frequency band of 5 GHz is selected (Step S807). The data is then transmitted at the selected frequency band (Step S808).

Thus, the transmission frequency is automatically switched to a frequency band best suited to a signal to be transmitted.

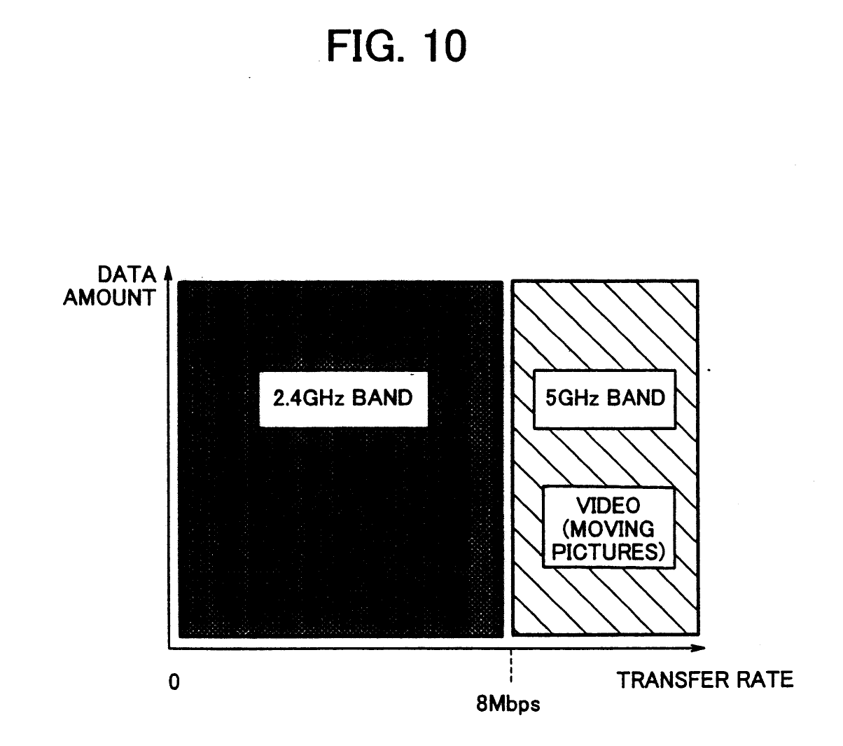

FIG. 10 shows a criterion by which the home server decides switching a frequency band by automatic frequency switching means added to the transmitting means for transmitting data from the home server to the display device according to the present invention.

Switching a frequency band from one to another is conducted on the following principle.

The selection of a transfer rate of a high quality video is a very important problem. To solve this problem, the present invention adopts the IEEE802.11a Standard for high-speed SS radio communications in addition to a 2.4 GHz frequency band used for conventional radio communications.

Switching a frequency band depends on an amount of transmittable data, for example, by the criterion shown in FIG. 10.

In FIG. 10, the transfer rate (Mbps) is expressed on the horizontal axis and the data volume (MB) is expressed on the vertical axis. The value of 8 Mbps maybe adopted as the threshold value. The 2.4 GHz frequency band is applied for data requiring transmission at a transfer rate lower than the threshold while the 5 GHz frequency band is applied for data requiring transmission at a transfer rate higher than the threshold.

In practice, the 5 GHz frequency band is applied for transmitting external broadcasting signals 1 to 3, communication signals 4 and real-time video (motion pictures) recorded on the portable recording device (package media) 56 and the internal recording device 55.

A large amount of data may be transmitted by radio of 5 GHz.

However, the 2.4 GHz frequency band may be also used for transmitting real-time video signals if they were compressed by a suitable method.

FIG. 11 is a block diagram showing a construction of a display device composing a home network system according to the present invention.

The display device 6 comprises an aerial portion 71 for capturing radio transmission 21, a radio control portion 72, a display device (signal conversion device) recognition control portion 721 for identifying itself, a signal processing portion 73 and a display portion 74. The display device 6 is further provided with a signal control portion 75 that controls a spatially transmitted light sensor portion 76 for receiving infrared transmission 23 from a remote control 7 serving as an interface with the display device, an aerial portion/radio control portion 77 for receiving radio transmission 23a from a remote control 7a and a connection terminal 75 for receiving signals from a keyboard 78 and a mouse 8.

The display device is also provided with a memory card slot 80 for insertion of a memory card therein and a digital video (DV) terminal 79 for connection of a video movie 10.

The operation of the display device 6 is described below with reference to FIG. 11.

The user turns on the display device 6 by using the remote control 7 or 7a. Then, the user selects a desired broadcast or video channel by using the remote control 7 or 7a.

The remote control 7 uses the infrared transmission 23 and the remote control uses the radio transmission 23a. The request signal from the remote control 7 or 7a is transmitted by infrared or radio and received by the spatially transmitted light sensor portion 76 or the aerial portion/radio control portion 77 and transferred to the signal control portion 75 in the display device 6.

The request signal is transferred from the signal control portion 73 to the device recognition control portion 721 that in turn adds address information of the display device 6 to the request signal and transfers the request signal with the address information to the radio control portion 72.

The request signal is modulated for radio transmission 21 by the radio control portion 72 and then transmitted through the aerial portion 71 to the home server 5.

The request signal transmitted from the display device 6 is received by the home server 5.

The operation of the home server 5 is now described below with reference to FIG. 5.

The request signal 21 is input through the aerial portion 60 into the home server 5 in which it is first demodulated by the radio control portion 58. The demodulated request signal is transferred to the signal control portion 54 whereby the broadcast channel selected by the user is decided based on the request signal and the information is transferred through the digital signal processing portion 52 to the external signal receiving and demodulating portion 51. The requested broadcast is received and demodulated by the portion 51 and video signals of the selected broadcast channel are then converted into common data signals by the digital signal processing portion 52. The common data (video) signals through the signal control portion 54 to the radio control portion 58. The transmitting means (radio or cable) is decided by the signal control portion 58 based on the address of the display device 6. The video signals are modulated by the radio control portion 58 and transmitted through the aerial portion 60 to the display device 6 that has transmitted the request signal.

The video signals transmitted from the home server 5 is received and displayed by the display device 6. Referring again to FIG. 11, the operation of the display device is described below.

The video signals 21 transmitted from the home server 5 is input through the aerial portion 71 into the display device 6 in which it is first demodulated by the radio control portion 72 and transferred to the device recognizing/processing portion 721 for recognizing that the correct address of the display device 6 has been attached to the video signals.

If the video signals have an incorrect address, they are shut off by the device recognizing/processing portion 721. The correctly addressed video signals are supplied further to the signal processing portion 73 by which the video signals are supplied to the display portion 74 on which the video signals received from the home server 5 are successively displayed.

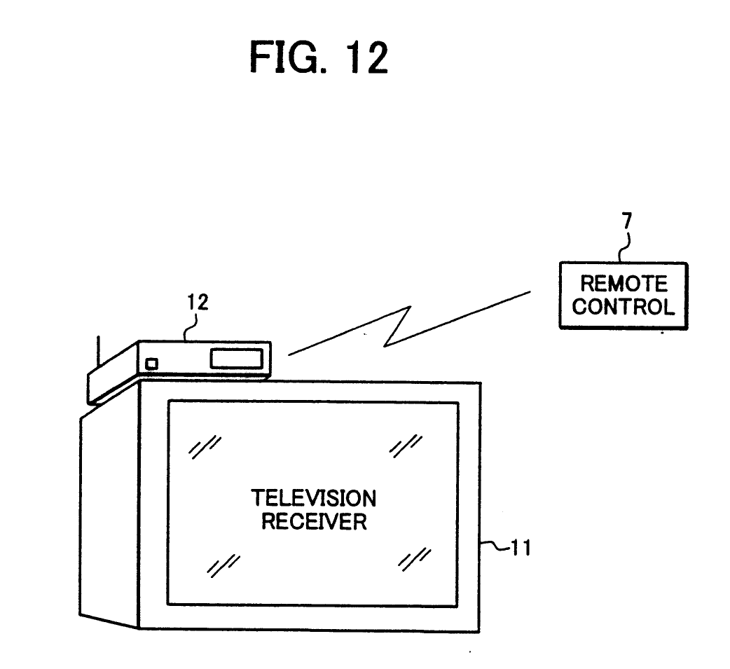

FIG. 12 illustrates an external appearance of a signal conversion device composing a home network system of the present invention.

This device receives audiovisual signals transmitted from the home server 5 and then supplies the audiovisual signals to an existing television receiver 11 lacking a function to receive the video signals directly from the home sever 5. In other words, the audiovisual information from the home server 5 via the signal conversion device 12 can be displayed on the television receiver 11 that cannot directly receive the signals from the home server 5. In this case, the selection of a desired broadcast channel is conducted by using a remote control 7 (or 7a) for the signal conversion device 12.

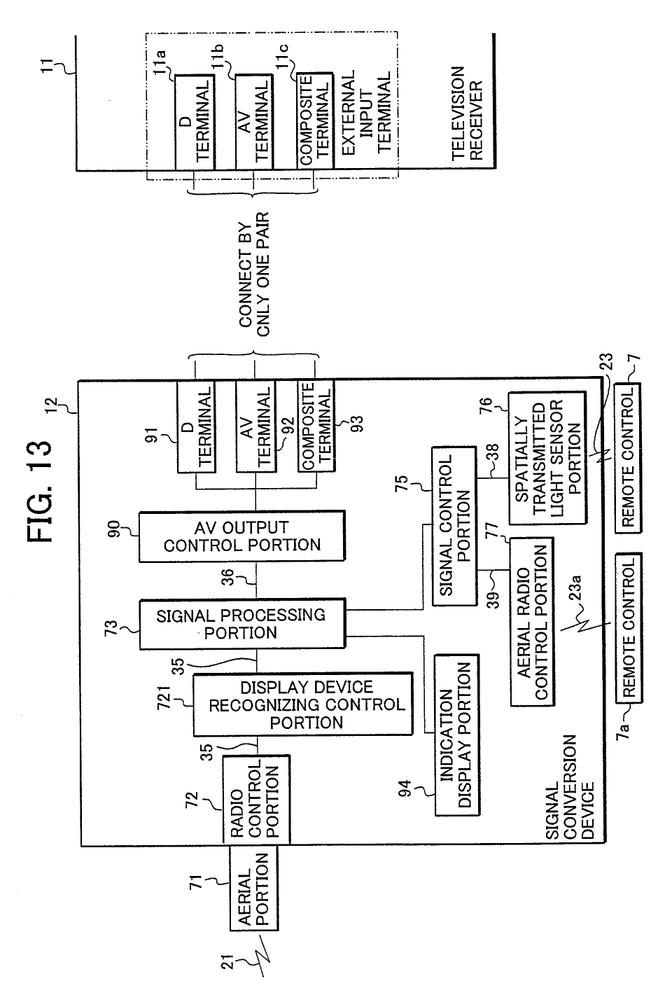

FIG. 13 is a block diagram showing a construction of a signal conversion device composing a home network system according to the present invention.

The signal conversion device 12 for receiving the radio transmission 21 from the home server comprises an aerial portion 71 for capturing the radio transmission 21, a radio control portion 72, a display device (signal conversion device) recognition control portion 721 for identifying itself by a given address, a signal processing portion 73, a spatially transmitted light sensor portion 76 for receiving infrared transmission 23 from a remote control 7 serving as an interface with the signal conversion device and an aerial portion/radio control portion 77 for receiving radio transmission 23a from a remote control 7a.

The signal conversion device 12 is further provided with a display portion 94 for indicating information on an AV broadcast channel currently selected and received from the home server 5 and a plurality of connection terminals such as a D-terminal 91, an AV-terminal 92 and a composite terminal 93.

The signal processing portion 73 converts the received video signals into television signals and supplied the converted signals through the AV output control portion 90 to the D-terminal 91, the AV-terminal 92 and the composite terminal 93.

The existing television receiver 11 is provided with external input terminals 11a (D-terminal), 11b (AV terminal) and 11c (composite terminal).

The operation of the signal conversion device 12 when watching a desired broadcast or video program on the existing television receiver is as follows:

The user turns on the signal conversion device 12 by using the remote control 7 or 7a. Then, the user selects a desired broadcast or video channel by using the remote control 7 or 7a. The remote control 7 uses the infrared transmission 23 and the remote control 7a uses the radio transmission 23a.

The request signal from the remote control 7 or 7a is transmitted by infrared 23 or radio 23a and received by the spatially transmitted light sensor portion 76 or the aerial portion/radio control portion 77 and transferred to the signal control portion 75 in the signal conversion device 12.

The request signal is transferred to the signal control portion 75 and the signal processing portion 73. Then, on the device recognition control portion 721 whereby address information of the signal conversion device 12 is added to the request signal and the request signal with the address information is transferred to the radio control portion 72.

The request signal is modulated for radio transmission 21 by the radio control portion 72 and then transmitted through the aerial portion 71 to the home server 5.

The request signal transmitted from the signal conversion device 12 is received by the home server 5.

The operation of the home server 5 is now described below with reference to FIG. 5.

The request signal 21 transmitted from the signal conversion device 12 is input through the aerial portion 60 into the home server 5 in which it is first demodulated by the radio control portion 58. The demodulated request signal is transferred through the radio/cable switching portion 68 to the signal control portion 54 whereby information on the broadcast channel selected by the user is recognized based on the request signal and supplied through the digital signal processing portion 52 to the external signal receiving and demodulating portion 51.

The selected broadcast is demodulated by the portion 51 and video signals of the selected broadcast channel are then converted into common data signals by the digital signal processing portion 52.

The converted video signals is transferred through the signal control portion 54 to the radio/cable switching portion 63 whereby the transmitting means (radio or cable) is selected based on the address of the of the signal conversion device 12. The converted video signals are transferred to the radio control portion 58. The video signals are modulated by the radio control portion 58 and transmitted through the aerial portion 60 to the signal conversion device 12 that has transmitted the request signal.

The video signals transmitted from the home server 5 is received and displayed by the signal conversion device 12. Referring again to FIG. 13, the operation of the signal conversion device 12 is described below.

The video signals 21 transmitted from the home server 5 is input through the aerial portion 71 into the signal conversion device 12 in which it is first demodulated by the radio control portion 72 and transferred to the device recognition control portion 721 for recognizing that the correct address of the signal conversion device 12 has been attached to the video signals.

If the video signals have an incorrect address, they are shut off by the device recognition control portion 721.

The correctly addressed video signals are supplied further to the signal processing portion 73 whereby they are converted into television signals. The television signals are then supplied through the AV output control portion 90 to the D-terminal 91, AV-terminal 92 and the composite terminal 93, which are connected to corresponding input terminals 11a (D-terminal), 11b (AV-terminal) and 11c (composite terminal), respectively, of the existing television receiver 11. The television signals are thus input and successively displayed on the television receiver 11.

The home server 5 also has a personal computer function for performing calculation and control operations. Referring to FIG. 5, the operation of the home server 5 is now described below.

The input devices are connected to the display device by connection PS/2 or USB adopted for the personal computer. The connection may be done by cable or radio. These input devices do not interfere with the interface of the display device. The home server may have a function for outputting to a printer.

To use the personal computer function of the home server, a keyboard/mouse 8 is connected to the connection terminal 78 of the display device 6. An operation/control signal 24 inputted to the display device 6 by using the keyboard/mouse 8 is transmitted by radio 21 to the home server 5. Upon receipt of the command signal 24, the home server 5 transmits a requested video signal through the personal computer control portion (control means) 53 and the transmitting means to the display device 6.

The personal computer control portion 53 has a function for communicating with the outside through a contracted service provider by sending and receiving communication signal 4 over a telephone line.

The command signal 24 from the keyboard/mouse 8 is input through the wired connection terminal 78 into the display device 6 in which it is transferred to the signal control portion 75 and the signal processing portion 73 with reference to FIG. 11. In the device recognition control portion 721, address information of the display device 6 is added to the request signal 24 that is then transferred to the radio control portion 72.

The request signal is modulated for radio transmission 21 by the radio control portion 72 and then transmitted through the aerial portion 71 to the home server 5.

The request signal transmitted from the display device 6 is received by the home server 5.

The operation of the home server 5 is now described below with reference to FIG. 5.

The request signal 21 from the display device 6 is input through the aerial portion 60 into the home server 5 in which it is first demodulated by the radio control portion 58.

The demodulated request signal 21 is transferred to the signal control portion 54 whereby the requested computer operation/control is conducted based on the request signal by using the personal computer control portion 53.

The output information from the computer control is converted into common data signal through the signal control portion 54. The converted video signal is supplied through the signal control portion 54 to the device recognizing portion 631 whereby it is provided with the address of the display device 6. The converted video signal together with address information is supplied to the radio control portion 58 whereby it is modulated and then transmitted through the aerial portion 60 to the display device 6 having dispatched the request signal.

The output signal transmitted from the home server 5 is received and displayed by the display device 6.

The operation of the display device 6 is as follows:

As shown in FIG. 11, the output signal 21 transmitted from the home server 5 is captured by the aerial portion 71 of the display device 6. In the display device 6, the received video signal 21 is demodulated by the radio control portion 72 and then transferred to the device recognition control portion 721 whereby the output signal 21 is shut off if it has the incorrect address information. The correctly addressed output signal is transferred to the signal processing portion 73 and then supplied to the display portion 74.

The output signal 21 transmitted from the home server 5 is displayed on the display portion 74.

As be apparent from the foregoing, the home network system according to the present invention comprises a home server capable of receiving all broadcasts, connecting to communication networks (telephone lines), reproducing package media, recording a large amount of data signals and performing personal computer functions and a plurality of display devices each having a LCD display and a communicating function, wherein each display device can receive any desired signals processed by the functions of the home server by radio at any place within the working area of the home network.

The use of a thin and light display device with a LCD element enables the user to receive any of broadcasts and video information available from the home server anytime at any place in an own house.

In the home network system according to present invention, the home server can communicate with plural display devices at the same time, enabling family members to concurrently enjoy different broadcasts on separate display devices located in different rooms.

Furthermore, any existing television receiver lacking a function for receiving information directly from the home server may be connected to the home server via a signal conversion device through which it may receive all data signals processed by the home server by using its functions (for receiving all broadcasts, connecting to communication networks, reproducing package media, recording a large amount of data signals and performing personal computer functions). The signal conversion device connected to the television receiver may be located at any desired place within the working area of the home network system.

In the home network system according to the present invention, the home server can communicate with a plurality of the display devices and signal conversion devices at the same time, enabling family members to concurrently enjoy different broadcasts on different display devices at different places.

1. A home network system comprising:
a home server including a first receiving means for receiving a plurality of broadcast signals and communication signals, a digital signal converting means for converting the received signals into digital signals, a recording means for recording the digital signals and a transmitting means for transmitting the digital signals; and
a display device including a second receiving means for receiving the digital signals from the home server and a display means for displaying the received digital signals.

2. A home network system as defined in claim 1, wherein the first receiving means is capable of receiving a plurality of signals including signals of satellite broadcasts, television broadcasts, cable television programs and telecommunications.

3. A home network system as defined in claim 1 or 2, wherein the home server and the display device are provided with a mutual recognition means by which the home server sends a recognition signal, the display device receives, recognizes the recognition signal and returns a response signal and the home server receives the returned response signal and gives an address to the display device.

4. A home network system as defined in claim 1, wherein the digital signal converting means converts a signal into common data signal and the transmitting means transmits the common data signal to the display device by radio.

5. A home network system as defined in claim 1, wherein the transmitting means is provided with a radio control means including a transmission power control means for discriminating a construction of a house wherein the home network system is working and a transmission direction control means for changing a direction of radio transmission.

6. A home network system as defined in claim 5, wherein the radio control means is provided with an automatic frequency control means for automatically maintaining an optimal bandwidth of the radio transmission.

7. A home network system as defined in claim 5, wherein the radio control means is provided with a frequency band switching means for changing a frequency band in accord with the type of transmittable data.

8. A home network system as defined in claim 1, wherein the display device can be used as a monitor of a personal computer and is provided with terminals for connecting thereto a keyboard and a mouse usable for operating the personal computer.

9. A home network system as defined in claim 1, wherein the display device is provided with terminals for connecting thereto a spatial light transmitting element or radio transmission element for starting and remotely controlling the home server for beginning to receive broadcast signals or get into communication.

10. A home network system comprising:
a home server including a receiving means for receiving a plurality of broadcast signals and communication signals, a digital signal converting means for converting each received signal into a digital signal, a recording means for recording the digital signal and a transmitting means for converting the digital signal into a high frequency signal and transmitting the high frequency signal;
a signal conversion device for receiving the high frequency signal from the home server, converting the high frequency signal into a television signal and transmitting the television signal; and
a television receiver for receiving the television signal from the signal conversion device.

11. A home network system as defined in claim 10, wherein the signal conversion device comprises a second receiving means for receiving a high frequency signal from the home server, a converting means for converting the received high frequency signal into a television signal and a outputting means for outputting the television signal to the television receiver.

12. A home network system as defined in claim 10 or 11, wherein the home server and the signal conversion device are provided with a mutual recognition means by which the home server sends a recognition signal, the signal conversion device receives, recognizes and returns the response signal and the home server receives the response signal and gives an address to the signal conversion device.

13. A home network system as defined in claim 10 or 11, wherein the mutual recognition means is provided with an additional device discriminating means for detecting a newly added signal conversion device and causing the mutual recognition means to work.

14. A home network system as defined in claim 13, wherein the mutual recognition means is provided with an address identifying means to examine whether an address was given already to the signal conversion device having returned the recognition signal and, if so, add the same address, or, if not, add a new different address to the signal conversion device.

15. A home network system as defined in claim 2, wherein the digital signal converting means converts a signal into common data signal and the transmitting means transmits the common data signal to the display device by radio.

16. A home network system as defined in claim 3, wherein the digital signal converting means converts a signal into common data signal and the transmitting means transmits the common data signal to the display device by radio.

17. A home network system as defined in claim 2, wherein the transmitting means is provided with a radio control means including a transmission power control means for discriminating a construction of a house wherein the home network system is working and a transmission direction control means for changing a direction of radio transmission.

18. A home network system as defined in claim 3, wherein the transmitting means is provided with a radio control means including a transmission power control means for discriminating a construction of a house wherein the home network system is working and a transmission direction control means for changing a direction of radio transmission.

19. A home network system as defined in claim 4, wherein the transmitting means is provided with a radio control means including a transmission power control means for discriminating a construction of a house wherein the home network system is working and a transmission direction control means for changing a direction of radio transmission.
